(19) United States
(12) Patent Application Publication
(10) Pub. No.: US 2006/0186388 A1
(43) Pub. Date: Aug. 24, 2006

(54) Emergency brake for hoist systems

(76) Inventors: Asbjorn Eilert Thune, Blomsterdalen (NO); Rune Vabo, Nyborg (NO)

Correspondence Address: KNOBLE YOSHIDA & DUNLEAVY, LLC, Eight Penn Center, Suite 1350, 1628 John F. Kennedy Blvd., Philadelphia, PA, 19103, US

(21) Appl. No.: 11/064,870

(22) Filed: Feb. 24, 2005

(51) Int. Cl. B66D 1/14

(52) U.S. Cl. 254/347

(57) ABSTRACT

A hoist assembly includes a frame, a hoist drum that is mounted for rotation with respect to the frame and a disc member, having first and second sides, that is mounted to rotate together with the hoist drum. First and second toothed wheels are connected to the rotatable hoist drum so as to rotate together with the rotatable hoist drum during normal hoist operation. First and second frictional bearing members are positioned, respectively, between the first and second sides of the disc member and the first and second toothed wheels. An adjustable compressive biasing system is provided in order to bias the first and second toothed wheels together. An arresting system is further provided for engaging the first and second toothed wheels simultaneously in order to preclude rotation of the toothed wheels during an emergency condition. Advantageously, a limited amount of relative rotation is permitted between the disc member and the first and second toothed wheels during arresting of the arresting system as a result of controlled slippage involving the first and second frictional bearing members.

### BACKGROUND OF THE INVENTION

1. Field of the Invention

This invention pertains to hoisting systems and, more particularly, to safety systems for heavy-duty hoisting systems that are designed for handling critical loads.

2. Description of the Related Technology

Typically, hoist systems of the type to which this invention pertains include a rotating drum that driven by a motor, and a grapple or other mechanism that is attached to the drum by means of a cable that is wrapped around the drum. As the drum rotates in one direction, it will raise the grapple, and when it rotates in a second, opposite direction it will lower the grapple.

Occasionally, an emergency situation will arise, such as when an overspeed condition is sensed or when system power is lost, that will require swift stoppage of the hoist mechanism. For that reason, it is typical for heavy-duty hoist mechanisms, and particularly those hoist mechanisms that are designed for use with critical payloads, to incorporate emergency braking systems. Conventionally, emergency braking systems have been incorporated into the drive train of the hoist drum. While such conventional emergency braking systems have proven to be generally effective, rapid engagement of the emergency braking system places stress on the drive train, and the presence of the emergency braking system within the drive train adds complexity and bulk to the drive train.

While it is important that an emergency braking system engage quickly in the event of an emergency situation, it is also important that the drive system, the hoist drum, and other mechanical components such as bearings are insulated somewhat from the shock of the initial engagement of the emergency braking system. It is also important that a critical load being handled by the hoist system not be decelerated too quickly. A need exists in this field of technology for an improved emergency braking system for hoists that can be quickly engaged in the event of an emergency situation, is independent from the drive train of the hoist and provides a measure of mechanical shock insulation to the mechanical elements of the hoist and the payload when it engages.

### SUMMARY OF THE INVENTION

Accordingly, it is an object of the invention to provide an improved emergency braking system for hoists that can be quickly engaged in the event of an emergency situation, is independent from the drive train of the hoist and provides a measure of mechanical shock insulation to the mechanical elements of the hoist and the payload when it engages.

In order to achieve the above and other objects of the invention a hoist assembly according to a first aspect of the invention includes a frame, a hoist drum that is mounted for rotation with respect to the frame, a first toothed wheel connected to the rotatable hoist drum so as to rotate therewith during normal hoist operation, an arresting system for engaging the first toothed wheel in order to arrest rotation of said toothed wheel during an emergency condition, and a frictional braking system mechanically interposed between the rotatable hoist drum and the first toothed wheel, whereby a limited amount of relative rotation is permitted between the rotatable drum and the first toothed wheel when the arresting system engages the first toothed wheel during an emergency condition.

According to a second aspect of the invention, a hoist assembly includes a frame, a hoist drum that is mounted for rotation with respect to the frame, a disc member that is mounted to rotate together with the hoist drum, a first toothed wheel connected to the rotatable hoist drum so as to rotate therewith during normal hoist operation, a second toothed wheel connected to the rotatable hoist drum so as to rotate therewith during normal hoist operation, a first frictional bearing member operably positioned between the first toothed wheel and a first side of the disc member, a second frictional bearing member operably positioned between the second toothed wheel and a second side of the disc member, a compressive biasing system for biasing the first and second toothed wheels toward each other, and an arresting system for engaging the first and second toothed wheels simultaneously in order to arrest rotation of the toothed wheels during an emergency condition, whereby a limited amount of relative rotation is permitted between the disc member and the first and second toothed wheels upon engagement of the arresting system as a result of controlled slippage involving the first and second frictional bearing members.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of a hoist system that is constructed according to a preferred embodiment of the invention;

FIG. 2 is a fragmentary cross-sectional view illustrating a portion of the hoist system that is shown in FIG. 1; and

FIG. 3 is a partially diagrammatical fragmentary cross-sectional view depicting another portion of the hoist system that is shown in FIG. 1.

### DETAILED DESCRIPTION OF THE PREFERRED EMBODIMENT(S)

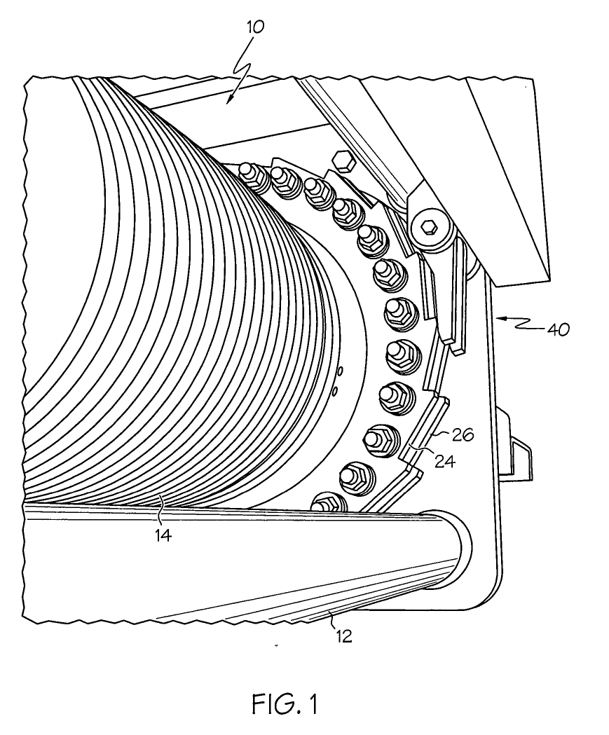

Referring now to the drawings, wherein like reference numerals designate corresponding structure throughout the views, and referring in particular to FIG. 1, a hoist system 10 that is constructed according to a preferred embodiment of the invention includes a frame 12 and a hoist drum 14 that is mounted for rotation with respect to the frame 12. A hoist system 10 is preferably, although not necessarily, designed for handling critical loads, such as containers of molten metallic material or nuclear material. It is especially critical in such applications that movement of the hoist drum 14 can be arrested quickly but as gently as possible in the event of an emergency situation.

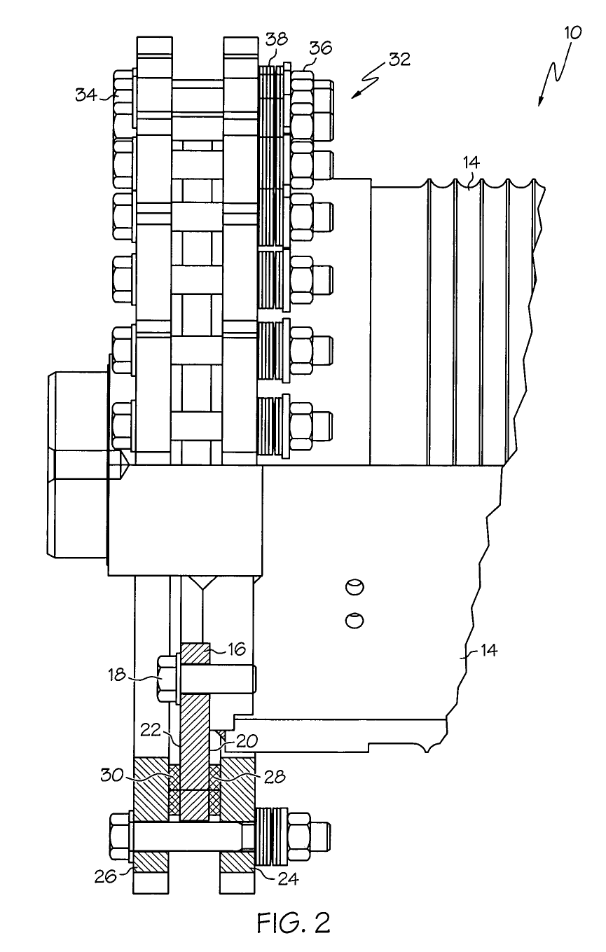

Referring now to FIG. 2, it will be seen that a disc member 16 is securely mounted to the hoist drum 14 at a distal end of the hoist drum 14 by means of a plurality of bolts 18. Accordingly, disc member 16 will rotate together with the hoist drum 14 under all conditions. Disc member 16 has a first side 20 facing the hoist drum 14 and a second, opposing side 22 that faces away from the hoist drum 14.

Looking to FIGS. 1 and 2, it will be seen that the hoist system 10 further includes first and second toothed wheels 24, 26 that are connected to the hoist drum 14 so as to rotate together with the hoist drum 14 during normal hoist operating conditions. A first frictional bearing member 28, as is best shown in FIG. 2, is interposed between the first side 20 of the disc member 16 and a flat interior side surface of the first toothed wheel 24 that faces the second toothed wheel 26. Similarly, a second frictional bearing member 30 is interposed between the second side 22 of the disc member 16 and a flat interior side surface of the second toothed wheel 26 that faces the first toothed wheel 24. The first and second frictional bearing members 28, 30 are preferably fabricated from the same material, which is preferably a non-asbestos conventional brake lining material, such as a composite material containing fibers that could be inorganic or organic and a matrix which could be coke, graphite, rubber, phenolic resin, metallic oxides, non fibrous silicate filler, other fillers or a combination thereof.

The first and second frictional bearing members 28, 30 are further preferably identical in shape and in size and in the area of frictional engagement surfaces that are presented to the disc member 16 and to the respective toothed wheels 24, 26. Preferably, the respective first and second frictional bearing members 28, 30 are secured to one of the disc member 16 or the respective toothed wheel 24, 26 so that relative motion of the frictional bearing member 28, 30 is limited during an emergency braking condition. In the preferred embodiment, both frictional bearing members 28, 30 are secured so that they will rotate together with the disc member 16 both during normal operating conditions and in the event of an emergency braking condition.

A compressive biasing system 32 is provided for impressively biasing the first and second toothed wheels 24, 26 toward one another both during normal hoist operation and in emergency braking conditions. In the preferred embodiment, compressive biasing system 32 includes a plurality of bolt members 34 that extend through the first and second toothed wheels 24, 26 without contacting the disc member 16 and a corresponding plurality of nuts 36 that are threaded on to the distal end of the respective bolt members 34. Preferably, at least one spring washer 38 is provided in each bolt/nut coupling so as to permit a greater range of adjustment of the compressive clamping force that is exerted by each one of the bolt/nut couplings. This permits adjustment of the compressive biasing system 32, which changes the braking force that is applied between the disc member 16 and the first and second toothed wheels 24, 26 during an emergency braking situation.

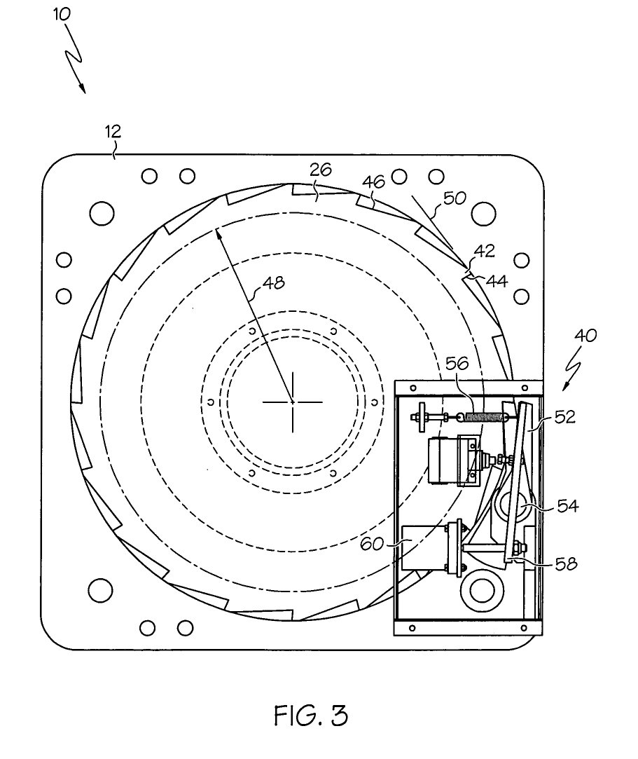

Referring now to FIG. 3, hoist system 10 further preferably includes an arresting system 40 for engaging the first and second toothed wheels 24, 26 simultaneously in the event of an emergency braking situation by arresting movement of both the first and second toothed wheel 24, 26 at the same time. As FIG. 3 shows, both the first and second toothed wheels 24, 26 include a plurality of ratchet like teeth 42. Each of the ratchet like teeth 42 has a first side surface 44 that is oriented at a relatively steep angle with respect to a tangent 50 of the toothed wheel 26 and a second side surface 46 that is oriented a relatively shallow angle with respect to the tangent 50. In the preferred embodiment, the first side surface 44 of each of the teeth 42 defines a plane that is slightly angled from being substantially parallel to a radius 48 of the toothed wheel 26. Preferably, the relatively steep angle will be approximately 95°. The first and second side surfaces 44, 46 intersect at a flattened toothed top that delimits the outer circumference of the toothed wheel 26.

The arresting system 40 preferably includes a pawl member 52 that is pivotally mounted with respect to the frame 12 by a pivot mount 54. A mechanical pawl biasing system embodied as a spring 56 is provided to continuously bias the pawl 52 toward engagement with the first and second toothed wheels 24, 26. During normal operation of the hoist system 10, an actuating system will be employed to displace the pawl member 52 away from the toothed wheels 24, 26 against the influence of the biasing that is provided by the spring 56. In the preferred embodiment, the actuating system includes a solenoid actuator 60 that is coupled to a lever arm extension 58 of the pawl member 52 that extends on the opposing side of the pivot mount 54.

Accordingly, in an emergency braking situation such as when an overspeed condition is sensed or when power ceases to be applied to the solenoid actuator 60 the pawl 52 will immediately engage the first side surface 44 of corresponding teeth 42 on both the first and second toothed wheels 24, 26, immediately halting movement of the toothed wheels 24, 26. The sudden arrest of the movement of the toothed wheels 24, 26 will impart considerable shock to the system, especially if the hoist system 10 is handling a heavy load. Much of the shock, however, will be absorbed by the braking effect that is created by the frictional engagement of the first and second frictional bearing members 28, 30 with the inner side surfaces of the first and second toothed wheels 24, 26. The amount of relative rotational movement that is permitted to occur between the toothed wheels 24, 26 and the hoist drum 14 depends upon the material from which the frictional bearing members 28, 30 are fabricated, the amount of compression that is being applied by the compressive biasing system 32 and the amount of force and speed of the hoist load and drive train to be absorbed. A considerable amount of the shock will be absorbed by the system, which will reduce the sudden deceleration of the load and reduce stress on the drive train of the hoist system 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

WHAT IS CLAIMED IS:

1. A hoist assembly, comprising:
a frame;
a hoist drum that is mounted for rotation with respect to said frame;
a first toothed wheel connected to said rotatable hoist drum so as to rotate therewith during normal hoist operation;
arresting means for engaging said first toothed wheel in order to arrest rotation of said toothed wheel during an emergency condition; and
frictional braking means mechanically interposed between said rotatable hoist drum and said first toothed wheel, whereby a limited amount of relative rotation is permitted between said rotatable drum and said first toothed wheel when said arresting means engages said first toothed wheel during an emergency condition.

2. A hoist assembly according to claim 1, wherein said frictional braking means is adjustable.

3. A hoist assembly according to claim 1, wherein said first toothed wheel has a plurality of teeth defined on an outer circumference thereof, and wherein at least one of said teeth has a first side surface that is oriented at a relatively steep angle with respect to a tangent of said first toothed wheel, and wherein said arresting means comprises at least one pawl that is constructed and arranged to engage said first side surface of said tooth in order to arrest rotation of said toothed wheel during an emergency condition.

4. A hoist assembly according to claim 3, wherein said first side surface defines a plane that is substantially parallel to a radius of said first toothed wheel, whereby said first side surfaces oriented at approximately a 95° angle with respect to a tangent of said toothed wheel.

5. A hoist assembly according to claim 3, wherein said tooth has a second side surface that is oriented at a relatively shallow angle with respect to a tangent of said first toothed wheel, and wherein said first and second side surfaces intersect at an outer circumferential edge.

6. A hoist assembly according to claim 3, wherein said arresting means further comprises pawl biasing means for biasing said pawl toward said first toothed wheel and actuating means for displacing said pawl away from said first toothed wheel during normal operation of said hoist, whereby said pawl will be urged into arresting with said toothed wheel in an emergency situation wherein said actuating means is left without power.

7. A hoist assembly according to claim 3, wherein said pawl is pivotally mounted to said frame.

8. A hoist assembly according to claim 6, wherein said actuating means comprises a solenoid actuator.

9. A hoist assembly according to claim 6, wherein said pawl biasing means comprises a spring.

10. A hoist assembly according to claim 1, wherein said frictional braking means comprises a disc member having first and second sides that is mounted for rotation with said hoist drum, a first frictional bearing member that is operably positioned between a first side of said disc member and said first toothed wheel, and compressive biasing means for compressively biasing said first frictional bearing member between said first side of said disc member and said first toothed wheel.

11. A hoist assembly according to claim 10, wherein said frictional bearing member is secured to one of said disc member and said first toothed wheel.

12. A hoist assembly according to claim 11, wherein said frictional bearing member is secured to said disc member.

13. A hoist assembly according to claim 11, further comprising a second toothed wheel and a second frictional bearing member that is operably positioned between said second side of said disc member and said second toothed wheel.

14. A hoist assembly according to claim 13, wherein said second toothed wheel is substantially of the same outer dimensions as said first toothed wheel.

15. A hoist assembly according to claim 14, wherein said second toothed wheel is further substantially symmetrical with said first toothed wheel, and wherein teeth on said first toothed wheel are in substantial registration with corresponding teeth on said second toothed wheel.

16. A hoist assembly according to claim 13, wherein said compressive biasing means is effective to bias said first and second toothed wheels toward one another.

17. A hoist assembly according to claim 16, wherein said compressive biasing means comprises a plurality of bolt/nut couplings that are positioned to clamp said first and second toothed wheels together, whereby a balanced compressive force will be applied to both said first and second frictional bearing members.

18. A hoist assembly according to claim 17, further comprising a plurality of spring members operatively positioned within a plurality of said bolt/nut couplings.

19. A hoist assembly according to claim 18, wherein said spring members comprise spring washers.

20. A hoist assembly according to claim 13, wherein said second frictional bearing member is substantially symmetrical in size and in shape to said first frictional bearing member.

21. A hoist assembly according to claim 13, wherein said second frictional bearing member is fabricated from the same material as said first frictional bearing member.

22. A hoist assembly according to claim 13, wherein said arresting means comprises a pawl that is constructed and arranged to simultaneously engage said first and second toothed wheels in order to arrest rotation of said toothed wheels during an emergency condition.

23. A hoist assembly according to claim 22, wherein said arresting means further comprises pawl biasing means for biasing said pawl toward said first toothed wheel and actuating means for displacing said pawl away from said first toothed wheel during normal operation of said hoist, whereby said pawl will be urged into arresting with said toothed wheel in an emergency situation wherein said actuating means is left without power.

24. A hoist assembly according to claim 22, wherein said pawl is pivotally mounted to said frame.

25. A hoist assembly according to claim 23, wherein said actuating means comprises a solenoid actuator.

26. A hoist assembly according to claim 23, wherein said pawl biasing means comprises a spring.

27. A hoist assembly, comprising:
a frame;
a hoist drum that is mounted for rotation with respect to said frame;
a disc member that is mounted to rotate together with said hoist drum;
a first toothed wheel connected to said rotatable hoist drum so as to rotate therewith during normal hoist operation;
a second toothed wheel connected to said rotatable hoist drum so as to rotate therewith during normal hoist operation;
a first frictional bearing member operably positioned between said first toothed wheel and a first side of said disc member;
a second frictional bearing member operably positioned between said second toothed wheel and a second side of said disc member;
compressive biasing means for biasing said first and second toothed wheels toward each other; and
arresting means for engaging said first and second toothed wheels simultaneously in order to arrest rotation of said toothed wheels during an emergency condition, whereby a limited amount of relative rotation is permitted between said disc member and said first and second toothed wheels upon engagement of said arresting means as a result of controlled slippage involving said first and second frictional bearing members.

28. A hoist assembly according to claim 27, wherein said compressive biasing means is adjustable.

29. A hoist assembly according to claim 27, wherein said first and second toothed wheels both have a plurality of teeth defined on respective outer circumferences thereof, and wherein at least one of said teeth on each of said wheels has a first side surface that is oriented at a relatively steep angle with respect to a tangent of said respective wheel, and wherein said arresting means comprises at least one pawl that is constructed and arranged to engage said first side surfaces of said respective teeth in order to arrest rotation of said first and second toothed wheels during an emergency condition.

30. A hoist assembly according to claim 29, wherein said first side surface of each of said teeth defines a plane that is substantially parallel to a radius of said respective toothed wheel, whereby said first side surfaces are oriented substantially at a 90° angle with respect to a tangent of said respective toothed wheel.

31. A hoist assembly according to claim 29, wherein said tooth has a second side surface that is oriented at a relatively shallow angle with respect to a tangent of said respective toothed wheel, and wherein said first and second side surfaces intersect at an outer circumferential edge.

32. A hoist assembly according to claim 29, wherein said arresting means further comprises pawl biasing means for biasing said pawl toward said toothed wheels and actuating means for displacing said pawl away from said toothed wheels during normal operation of said hoist, whereby said pawl will be urged into arresting with said toothed wheels in an emergency situation wherein said actuating means is left without power.

33. A hoist assembly according to claim 29, wherein said pawl is pivotally mounted to said frame.

34. A hoist assembly according to claim 32, wherein said actuating means comprises a solenoid actuator.

35. A hoist assembly according to claim 32, wherein said pawl biasing means comprises a spring.

36. A hoist assembly according to claim 27, wherein said second toothed wheel is substantially of the same outer dimensions as said first toothed wheel.

37. A hoist assembly according to claim 36, wherein said second toothed wheel is further substantially symmetrical with said first toothed wheel, and wherein teeth on said first toothed wheel are in substantial registration with corresponding teeth on said second toothed wheel.

38. A hoist assembly according to claim 27, wherein said compressive biasing means comprises a plurality of bolt/nut couplings that are positioned to clamp said first and second toothed wheels together, whereby a balanced compressive force will be applied to both said first and second frictional bearing members.

39. A hoist assembly according to claim 38, further comprising a plurality of spring members operatively positioned within a plurality of said bolt/nut couplings.

40. A hoist assembly according to claim 39, wherein said spring members comprise spring washers.

41. A hoist assembly according to claim 27, wherein said second frictional bearing member is substantially symmetrical in size and in shape to said first frictional bearing member.

42. A hoist assembly according to claim 27, wherein said second frictional bearing member is fabricated from the same material as said first frictional bearing member.
